(19) United States
(12) Patent Application Publication
(10) Pub. No.: US 2013/0024878 A1
(43) Pub. Date: Jan. 24, 2013

(54) SPINDLE MOTOR

(71) Applicants: Yong Kwan Lee, Gyunggi-do (KR); Sun Kim, Gyunggi-do (KR); Dae Hyun Kwon, Gyunggi-do (KR); Hyun Su Kim, Gyunggi-do (KR)

(72) Inventors: Yong Kwan Lee, Gyunggi-do (KR); Sun Kim, Gyunggi-do (KR); Dae Hyun Kwon, Gyunggi-do (KR); Hyun Su Kim, Gyunggi-do (KR)

(73) Assignee: SAMSUNG ELECTRO-MECHANICS CO., LTD., Gyunggi-do (KR)

(21) Appl. No.: 13/299,516

(22) Filed: Nov. 18, 2011

(30) Foreign Application Priority Data
Jul. 18, 2011 (KR) 1020110070973

(51) Int. Cl. G11B 17/03

(52) U.S. Cl. 720/703; G9B/17.009

(57) ABSTRACT

Disclosed herein is a spindle motor including: a turn table made of a deformable iron based material; a turn table inner diameter part provided at the center of the turn table, having a hollow part, and including a coupling part formed in an inner peripheral surface thereof; and a shaft inserted into the hollow part of the turn table inner diameter part to thereby contact the coupling part and rotate in an axial direction.

### CROSS REFERENCE TO RELATED APPLICATION

This application claims the benefit of Korean Patent Application No. 10-2011-0070973, filed on Jul. 18, 2011, entitled “Spindle Motor” which is hereby incorporated by reference in its entirety into this application.

### BACKGROUND OF THE INVENTION

1. Technical Field

The present invention relates to a spindle motor.

2. Description of the Related Art

A spindle motor or an optical disk drive (ODD) motor is a core driving device supporting input and output of data to and from a computer or a peripheral device through an optical pickup or data scriber disposed at a lower portion thereof. Performance of the spindle motor depends on capability to accurately control a posture of a media device such as a compact disk (CD) or a digital versatile disk (DVD). When a wobble phenomenon in which a disk moves during driving, or the like, occurs, the input and output of data is not smoothly performed, which leads to customer complaints to thereby have a large effect on future business.

The spindle motor according to the prior art has been assembled in a forced press-fitting scheme at the time of direct assembly between a turn table and a shaft supporting rotation. The forced press-fitting scheme has an advantage in that two components may be rapidly assembled to each other. However, a press-fitting condition of a product is managed in consideration of a tolerance between two components, such that uniformity of the product is bad, and a pushing phenomenon occurs toward a material having weak rigidity at the time of press-fitting, such that plastic deformation of the product may occur.

When the plastic deformation of the product occurs, a worker needs to manually perform calibration work in order to adjust perpendicularity between the shaft and the turn table, which may cause loss of productivity. In addition, due to the plastic deformation, a coupling part becomes weak, and a spring-back phenomenon, or the like, occurs, such that it is difficult to stably perform read and write operations in the CD and DVD. Further, this unstable assembling state causes the wobble phenomenon, thereby leading to many problems such as deterioration of product quality, and the like.

### SUMMARY OF THE INVENTION

The present invention has been made in an effort to provide a spindle motor capable of minimizing deformation of a turn table at the time of press-fitting of a shaft into the turn table and reducing the amount of calibration work of a product.

According to a first preferred embodiment of the present invention, there is provided a spindle motor including: a turn table made of a deformable iron based material; a turn table inner diameter part provided at the center of the turn table, having a hollow part, and including a coupling part formed in an inner peripheral surface thereof; and a shaft inserted into the hollow part of the turn table inner diameter part to thereby contact the coupling part and rotate in an axial direction.

The coupling part may have a groove shape or an embossing shape.

The coupling part may have an inner diameter that is equal to or smaller than an outer diameter of the shaft.

The coupling part may have shapes and sizes that are changed according to a longitudinal position of the turn table inner diameter part.

The shaft may have hardness larger than that of the turn table inner diameter part.

The turn table inner diameter part may be made of a deformable iron based material, and the coupling part formed in the turn table inner diameter part may be deformed when the shaft is inserted thereinto.

The shaft may be inserted into the turn table inner diameter part, and the shaft and the coupling part may include a bonding material filled in a space therebetween.

According to a second preferred embodiment of the present invention, there is provided a spindle motor including: a turn table made of a deformable iron based material, having a hollow part, and including a coupling part formed in an inner peripheral surface thereof; and a shaft inserted into the hollow part to thereby rotate in an axial direction.

The coupling part may have a groove shape or an embossing shape.

The coupling part may have an inner diameter that is equal to or smaller than an outer diameter of the shaft.

The coupling part may have shapes and sizes that are changed according to a longitudinal position.

The shaft may have hardness larger than that of the turn table inner diameter part.

The shaft may be inserted into the turn table inner diameter part, and the shaft and the coupling part may include a bonding material filled in a space therebetween.

### BRIEF DESCRIPTION OF THE DRAWINGS

FIG. 1 is a partial cross-sectional view of a spindle motor according to a preferred embodiment of the present invention;

FIG. 2 is a partially enlarged view of a spindle motor according to a preferred embodiment of the present invention;

FIGS. 3 and 4 are partially enlarged views of a spindle motor according to another preferred embodiment of the present invention; and

FIG. 5 is a partially enlarged top view of a spindle motor according to a preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

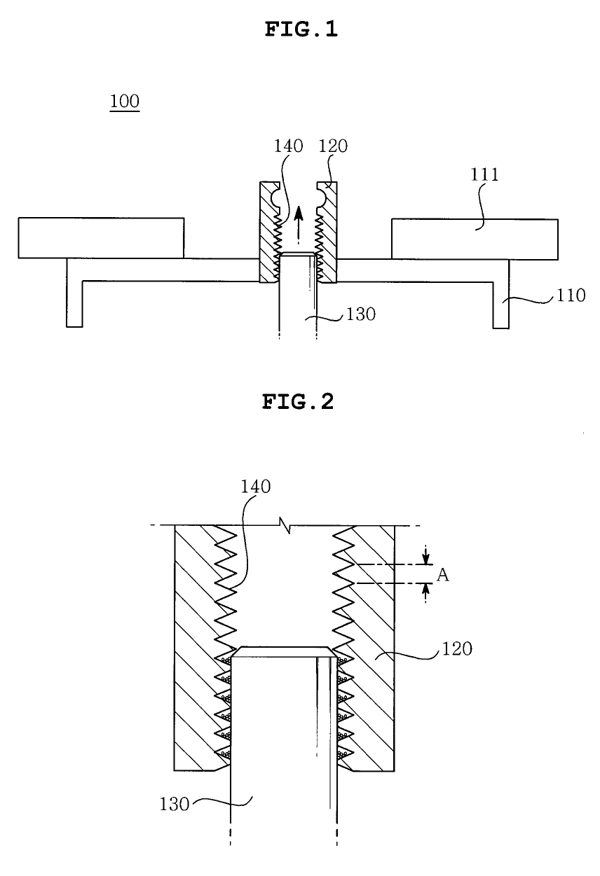

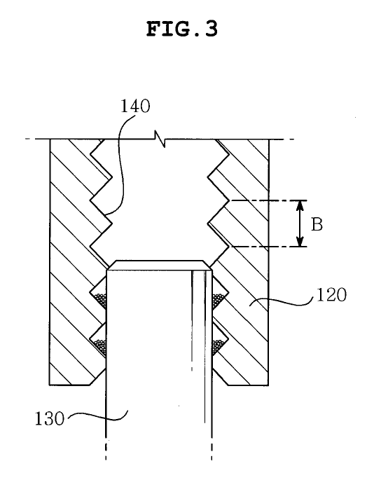

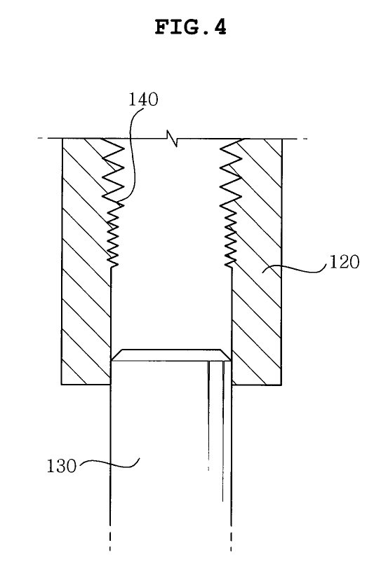

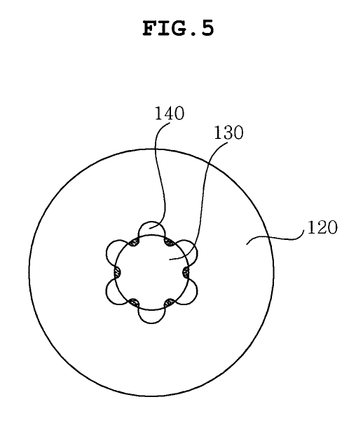

FIG. 1 is a partial cross-sectional view of a spindle motor according to a preferred embodiment of the present invention. FIG. 2 is a partially enlarged view of a spindle motor according to a preferred embodiment of the present invention; and FIGS. 3 and 4 are partially enlarged views of a spindle motor according to another preferred embodiment of the present invention. FIG. 5 is a partially enlarged top view of a spindle motor according to a preferred embodiment of the present invention.

As shown in FIG. 1, a spindle motor 100 according to a preferred embodiment of the present invention is configured to include a turn table 110, a turn table inner diameter part 120, and a shaft 130.

The spindle motor 100 according to the preferred embodiment of the present invention particularly relates to an optical disk drive (ODD) motor reading data of an optical disk or a media device.

The turn table 110 is a rotor part rotating based on the shaft of the motor and includes the turn table inner diameter part 120 formed at the center thereof, wherein the turn table inner diameter part 120 has a hollow part formed therein so that the shaft 130 is easily inserted thereinto.

The turn table 110 has an optical disk 111 mounted on an upper portion thereof. The optical disk 111 is fixed to the turn table 110 in a state in which the center thereof coincides with that of the shaft 130 so that the optical disk 111 is not separated from the turn table 110 at the time of rotation thereof.

The turn table inner diameter part 120 may be made of the same material as that of the turn table 110, that is, a deformable iron based material, and includes a coupling part 140 formed therein so that the shaft 130 is easily inserted into an inner diameter of the turn table 110.

The coupling part 140 of the turn table inner diameter part 120 is formed to have a shape in which it may absorb deformation in order to prevent the entire product from being deformed when the shaft 130 is inserted thereinto and fixed thereto, that is, a groove shape or an embossing shape.

When the coupling part 140 is not formed in the turn table inner diameter part 120, the shaft 130 is forcedly press-fitted into the turn table 110.

Due to this press-fitting, a material is pushed in a radial direction by a tolerance between a diameter of the shaft 130 and the inner diameter of the turn table 110, thereby causing deformation of the entire turn table 110.

The coupling part 140 formed in the turn table inner diameter part 120 may have an inner diameter that is equal to or smaller than an outer diameter of the shaft 130.

The coupling part 140 formed in the turn table inner diameter part 120 may have a volume that is equal to or larger than a volume amount in which the shaft 130 and the inner diameter of the coupling part 140 are overlapped with each other at the time of press fitting.

Since a problem occurs in separation force (unmating force) when the inner diameter of the coupling part 140 formed in the turn table inner diameter part 120 is not appropriate, it is preferable that the inner diameter of the coupling part 140 is adjusted by an appropriate amount.

The shaft 130, which is inserted into the turn table inner diameter part 120 to thereby rotate the entire motor, is inserted into the turn table inner diameter part 120 while contacting the coupling part 140 formed in the turn table inner diameter part 120 at the time of insertion into the turn table inner diameter part 120, and stress is transferred to the coupling part 140, thereby making it possible to prevent the entire product from being deformed.

The shaft 130 has hardness larger than that of the turn table inner diameter part 120.

The turn table 110 and the turn table inner diameter part 120 may be formed integrally with each other. That is, the coupling part 140 may also be formed in an inner peripheral surface of the turn table 110 having a hollow part.

FIG. 2, which is a partially enlarged view of the spindle motor 100 according to the preferred embodiment of the present invention, shows that the coupling part 140 is formed in the turn table inner diameter part 120.

The shaft 130 is inserted in a central penetration part of the turn table inner diameter part 120 provided at the center of the turn table 110 of the spindle motor 100 according to the preferred embodiment of the present invention. When the shaft 130 is inserted into the central penetration part of the turn table inner diameter part 120, it contacts the coupling part 140 formed in the turn table inner part 120.

Here, when the shaft 130 is inserted, it is fixedly inserted into the center of the turn table inner diameter part 120 while generating local deformation in the coupling part 140 due to the contact with the coupling part 140.

As described above, when the shaft 130 is inserted, it is fixed to the center of the turn table inner diameter part 120 while generating local deformation in the coupling part 140 of the turn table inner diameter part 120, thereby making it possible to prevent deformation of the entire motor.

The coupling part 140 of the turn table inner diameter part 120 may have various shapes, for example, a groove or an embossing shape having various sizes. In addition, the coupling part 140 may have shapes and sizes that are changed according to a longitudinal position of the turn table 110.

FIG. 3 shows the coupling part 140 formed in the turn table inner diameter part 120 of the spindle motor 100 according to the preferred embodiment of the present invention and having another shape.

The coupling part 140 shown in FIG. 3 has a size larger than that of the coupling part 140 shown in FIG. 2. As an example, the coupling part 140 may be variously formed according to a pitch interval as long as it has a screw thread shape.

For example, a length interval B of the coupling part 140 of FIG. 3 is larger than a length interval A of the coupling part 140 of FIG. 2.

FIG. 4 shows a coupling part 140 formed in a turn table inner diameter part 120 of a spindle motor 100 according to another preferred embodiment of the present invention.

As shown in FIG. 4, the coupling part 140 may also have shapes and sizes that are changed according to a longitudinal position of the turn table inner diameter part 120.

FIG. 5 shows that the coupling part 140 is formed in the turn table inner diameter part 120 of the spindle motor 100 according to the preferred embodiment of the present invention when viewed from the top.

As shown in FIG. 5, the shaft 130 is inserted into the center of the turn table inner diameter part 120. At this time, an outer diameter of the shaft 130 contacts the coupling part 140 formed in an inner peripheral surface of the turn table inner diameter part 120, such that the coupling part 140 is locally deformed or absorbs deformation stress.

Here, in order to reinforce unmating force, when the shaft 130 is inserted into the turn table inner diameter part 120, a space between the shaft 130 and the turn table inner diameter part 120 may also be fixed by a bonding material.

The spindle motor 100 according to the preferred embodiment of the present invention having the above-mentioned configuration includes the turn table 110, the turn table inner diameter part 120 formed at the center of the turn table 110, the coupling part 140 formed on the inner peripheral surface of the turn table inner diameter part 120, and the shaft 130 inserted into the inner peripheral surface.

When the shaft 130 is inserted into the coupling part 140, perpendicularity of the shaft 130 is adjusted while local deformation is generated in the coupling part 140.

In order to prevent the shaft 130 from being separated from the coupling part 140 after the shaft 130 is inserted into the coupling part 140, the coupling part 140 needs to have an inner diameter that is equal to or smaller than the diameter of the shaft 130.

Through the above-mentioned configuration, it is possible to minimize the deformation of the turn table 110 at the time of the insertion of the shaft 130 without significantly changing a design of the entire spindle motor 100. In addition, due to the minimization of the deformation, it is possible to reduce the amount of calibration work of a product such as work for adjusting the perpendicularity between the turn table 110 and the shaft 130, or the like.

Furthermore, even though slight eccentricity is generated between the shaft 130 and the turn table 110, press fitting force is not significantly increased due to local deformation.

Although the embodiment of the present invention has been disclosed for illustrative purposes, it will be appreciated that a spindle motor according to the invention is not limited thereto, and those skilled in the art will appreciate that various modifications, additions and substitutions are possible, without departing from the scope and spirit of the invention.

Accordingly, such modifications, additions and substitutions should also be understood to fall within the scope of the present invention.

What is claimed is:

1. A spindle motor comprising:
a turn table made of a deformable iron based material;
a turn table inner diameter part provided at the center of the turn table, having a hollow part, and including a coupling part formed in an inner peripheral surface thereof; and
a shaft inserted into the hollow part of the turn table inner diameter part to thereby contact the coupling part and rotate in an axial direction.

2. The spindle motor as set forth in claim 1, wherein the coupling part has a groove shape or an embossing shape.

3. The spindle motor as set forth in claim 1, wherein the coupling part has an inner diameter that is equal to or smaller than an outer diameter of the shaft.

4. The spindle motor as set forth in claim 1, wherein the coupling part has shapes and sizes that are changed according to a longitudinal position of the turn table inner diameter part.

5. The spindle motor as set forth in claim 1, wherein the shaft has hardness larger than that of the turn table inner diameter part.

6. The spindle motor as set forth in claim 1, wherein the turn table inner diameter part is made of a deformable iron based material, and the coupling part formed in the turn table inner diameter part is deformed when the shaft is inserted thereinto.

7. The spindle motor as set forth in claim 1, wherein the shaft is inserted into the turn table inner diameter part, and the shaft and the coupling part include a bonding material filled in a space therebetween.

8. A spindle motor comprising:
a turn table made of a deformable iron based material, having a hollow part, and including a coupling part formed in an inner peripheral surface thereof; and
a shaft inserted into the hollow part to thereby rotate in an axial direction.

9. The spindle motor as set forth in claim 8, wherein the coupling part has a groove shape or an embossing shape.

10. The spindle motor as set forth in claim 8, wherein the coupling part has an inner diameter that is equal to or smaller than an outer diameter of the shaft.

11. The spindle motor as set forth in claim 8, wherein the coupling part has shapes and sizes that are changed according to a longitudinal position.

12. The spindle motor as set forth in claim 8, wherein the shaft has hardness larger than that of the turn table inner diameter part.

13. The spindle motor as set forth in claim 8, wherein the shaft is inserted into the turn table inner diameter part, and the shaft and the coupling part include a bonding material filled in a space therebetween.
